(19) United States
(12) Patent Application Publication
(10) Pub. No.: US 2013/0177716 A1
(43) Pub. Date: Jul. 11, 2013

(54) METHOD OF MANUFACTURING A SUBSTRATE HAVING A TEXTURED SURFACE

(71) Applicant: D. Edward Wheatley, Macatawa, MI (US)

(72) Inventor: D. Edward Wheatley, Macatawa, MI (US)

(21) Appl. No.: 13/348,302

(22) Filed: Jan. 11, 2012

(51) Int. Cl. B05D 5/00; B05D 1/28; B05D 3/12; B05D 3/02

(52) U.S. Cl. 427/558

(57) ABSTRACT

A method for manufacturing a substrate having a textured surface. The method including the steps of: providing a substrate having a surface; applying a coating material onto the surface of the substrate; texturing the coating material on the surface of the substrate to form a textured coating; exposing the textured coating on the substrate to ultraviolet light for a duration of time sufficient to fully cure the textured coating on the substrate; and thereby forming a fully cured textured surface on the substrate.

### BACKGROUND

1. Field of the Invention

The present invention generally relates to the field of construction materials. More specifically, this invention relates to textured wallboards, as might be used in new construction or home remodeling, and the methods for their manufacture.

2. Description of Related Art

Various types of wallboards have been used for years in the construction trades. The most common form of wallboard used today is drywall, which is also known as plasterboard, gypsum board and sheetrock. Drywall is formed of gypsum plaster pressed between two sheets of relatively thick paper. Drywall itself is not structural and requires the building of an underlying wall, typically formed from a framework of 2×4 lumber, to which the drywall is secured. After securing the drywall on the wall, seams between adjacent sheets of the drywall must be taped, mudded and sanded, and the smooth, unfinished exterior surface must thereafter be primed and painted. If a textured surface is desired, the texture is applied after the drywall is hung, either before or after the priming of the exterior surface, by spraying on the texture material or other means.

Another form of wallboard is cement board. Cement board has either wood flakes or cellulose fiber, bonded together by cement, to form the panel. Texture is applied to cement board in similar fashion, but usually cement board is used as a backing board and is covered with tile.

A further type of wallboard is one made of magnesium oxide, and which is often referred to as magnesia board. These boards are often used in place of drywall and are not a paper faced panel. In addition to being fire resistant, these boards are also not susceptible to mold and mildew. For the latter reasons, magnesia boards are often used in place of drywall. Magnesia boards can also be incorporated into preformed wall systems, such as the insulated wall systems often used in the remodeling trade for refinishing basements.

One method of applying a texture to this type of wallboard involves providing a series of generally parallel textile strands, yarns or strings that are laid upon and adhesively secured to the board's surface. After the adhesive dries, the strands are trimmed. The textured panel can thereafter be primed and painted. Issues can arise, however, should one of the stands become dislodged from the board surface, either during manufacturing and installation or after installation.

### SUMMARY

In overcoming the enumerated drawbacks and other limitations of the related art, the present invention provides a novel method for forming a panel or board having a textured surface.

In one aspect of the invention, a method is provided for manufacturing a substrate having a textured surface, the method including the steps of: providing a substrate having a surface; applying a coating material onto the surface of the substrate; texturing the coating material on the surface of the substrate to form a textured coating; and exposing the textured coating on the substrate to ultraviolet light for a duration of time sufficient to fully cure the textured coating on the substrate and thereby form a fully cured textured surface on the substrate.

In another aspect, the step of applying the coating material to the surface of the substrate includes the step of first applying the coating material to a pair of counter rotating rollers.

In a further aspect, the step of applying the coating material to the surface of the substrate includes contacting at least one roller with the surface of the substrate thereby transferring coating material from the roller to the surface of the substrate.

In yet another aspect, the step of applying the coating material to the surface of the substrate includes roll coating the substrate in a coating station.

In still a further aspect of the invention, the surface of the substrate is planar.

In another aspect, the invention includes moving the substrate along a conveyor system during the coating, texturing and curing steps.

In a further aspect of the invention, the step of texturing the coating material on the surface of the substrate includes drawing the substrate with the coating material thereon past a doctor blade or board, the doctor blade having a profiled edge and the profiled edge contacting at least the coating material and thereby forming a texture in the coating material that corresponds with the shape of the profiled edge.

In a still further aspect of the invention, the profiled edge has a series of recesses formed therein.

In yet another aspect of the invention, the series of recesses is a random series of recesses.

In still another aspect of the invention, the series of recess is a repeating series of recesses.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a perspective view of production line for forming textured wall boards according to the principles of the present invention;

FIG. 2 is an enlarged view of the coating station and the texturing station seen in FIG. 1;

FIG. 3 is a downstream view of the doctor blade of the coating station showing the profiled edge that imparts the pattern or texture onto the coating on the surface of the substrate; and

FIG. 4 is a perspective view of a resultant wallboard manufactured in accordance with the principles of the present invention.

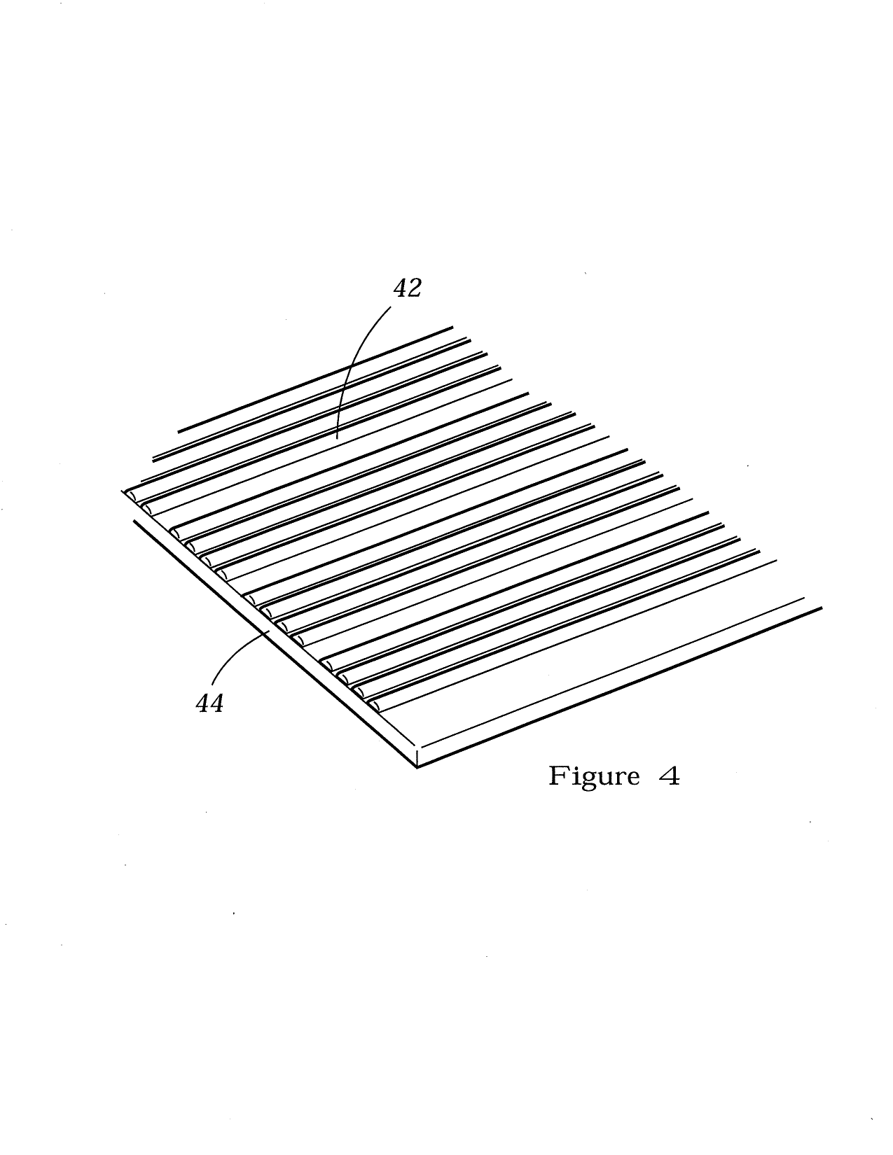

### DETAILED DESCRIPTION

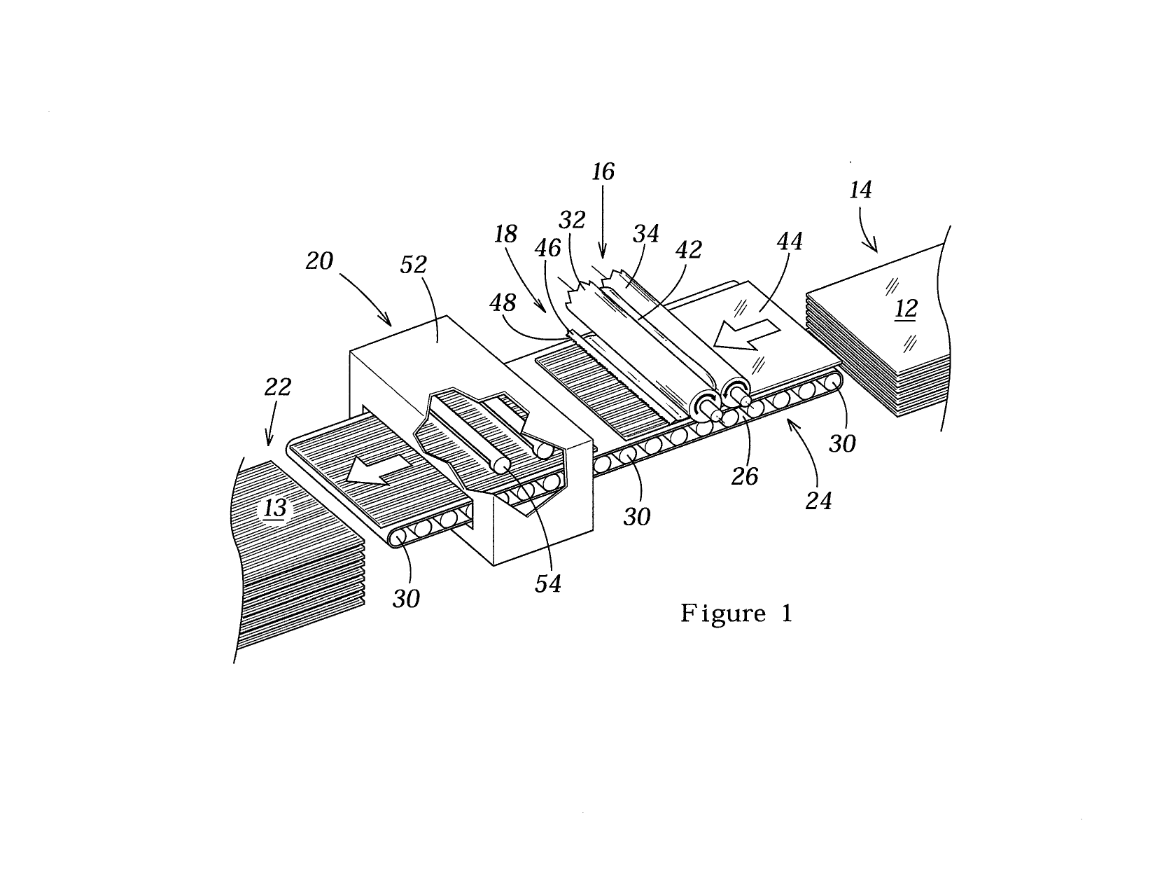

Referring now to the drawings, a production line for practicing a method in accordance with the principles of the present invention is illustrated therein and generally designated at 10. The production line 10, which is best seen in FIG. 1, is configured to continuously apply and fully form a texture surface on planar substrates 12. As such, the production line 10 has various stations for achieving this process. These stations principally include an in-feed station 14, a coating station 16, a texturing station 18, a curing station 20 and an out-feed station 22. While described herein as having specific stations, it will be readily apparent to those skilled in the art that variations on the stations are possible, as is the incorporation of additional stations and components into the production line 10.

At the initiation of a method in accordance with the principles of the present invention, the substrates 12 are loaded onto a conveyor assembly 24, such loading occurring either by an automated transfer mechanism or manually. The conveyor assembly 24 then carries the substrates 12 along the production line 10 and through the in-feed station 14, the coating station 16, the texturing station 18, the curing station 20 and the out-feed station 22 The conveyor assembly 24 may utilize various means to convey the substrates 12 through the stations 14-22. In a preferred embodiment, the conveyor assembly 24 employs an endless conveyor belt 26 that is driven by an electric motor (not shown) about a series of rollers 30. With the substrates 12 loaded onto the conveyor assembly 24, the substrates 12 are advanced by the conveyor belt 24 from the in-feed station 14 into the coating station 16.

The coating station 16 is a roll coater having a pair of rollers, which are herein referred to as a nip or coating roller 32 and a conditioning or doctor roller 34. Driven by an electric motor (not shown), the nip roller 32 and the conditioning roller 34 are counter-rotating relative to one another such that, as seen in the illustrated drawings, the nip roller 32 rotates in a clockwise direction (the bottom of the roller 32 adjacent to the conveyor belt 26 moving in the direction of movement of the belt 26) and the conditioning roller 34 rotates in a counter clockwise direction. While the nip roller 32 and the conditioning roller 34 may be constructed from a variety of materials, a preferred material for the nip roller 32 is ethylene propylene diene monomer (EPDM) and the preferred material for the conditioning roller 34 is chrome plated steel, each rollers 32, 34 being formed so as to have a smooth exterior surface.

At the upper side of the rollers 32, 34 (the side of the rollers away from the conveyor belt 26) a trough 36 is defined by the adjacent curvatures of the rollers 32, 34. This trough 36 may therefore be described as the generally triangular space between the nip roller 32 and the conditioning roller 34, where the two rollers rotate toward one another.

With the rollers 32, 34 counter rotating, a viscous coating material 38 is dispensed into the trough 36. The coating material 38 may be dispensed into the trough 36 at a central location, or it may be dispensed at multiple locations along the length of the trough 36. Accordingly, a wide variety of dispensing mechanisms (not shown) could be used for this purpose. The dispensing mechanism also can either continuously supply the coating material into the trough 36 or only periodically dispense the coating material 38. The rate at which the material 38 is provided into the trough 36 will depend, at least in part, on the rate at which the material 38 is being transferred to the substrate 12.

At least when received centrally in the trough 36, because of its viscous nature, the coating material 38 will initially pool in the central region of the rollers 32, 34. This collected pool of coating material 38 will eventually elongate, as a result of the rotating action of the nip and conditioning rollers 32, 34. The elongated coating material 38 forms a log 42 within the trough 36 that extends approximately the entire length of the nip and conditioning rollers 32, 34. As the coating material 38 is elongated by the counter rotating action of the rollers 32, 34, a certain amount of the coating material 38 adheres to the nip roller 32. The coating material's affinity for the chrome plated steel of the conditioning roller 34 is less than that for the EPDM material of the nip roller 32 and, therefore, a lesser amount of the coating material 38 adheres to the conditioning roller 34.

The nip roller 32 is positioned such that the nip roller 32 contacts the upper surface 44 of the substrate 12, as the substrate 12 is being conveyed on the conveyor belt 26 through the coating station 16. It is therefore desirable for the rotational speed of the nip roller 32 to correspond with the speed at which the substrates 12 are being conveyed in the production line 10. In a preferred embodiment, substrates 12 are being conveyed by the conveyor belt 26 at the rate of about 16 feet/minute. By contacting the upper surface 44 of the substrate 12, an amount of the coating material 38 is transferred from the nip roller 32 to the upper surface 44 of the substrate 12.

With the coating material 38 applied to the upper surface 44 of the substrate 12, this coated substrate 12 next encounters the texturing station 18 of the production line 10. In the texturing station 18, the coating material 38 on the substrate 12 is provided with a texture or pattern that becomes the ultimate surface texture/pattern on the resulting wall board 13. In the illustrated embodiment, this is achieved by providing a doctor blade 46 downstream of the nip roller 32 and before the curing station 20.

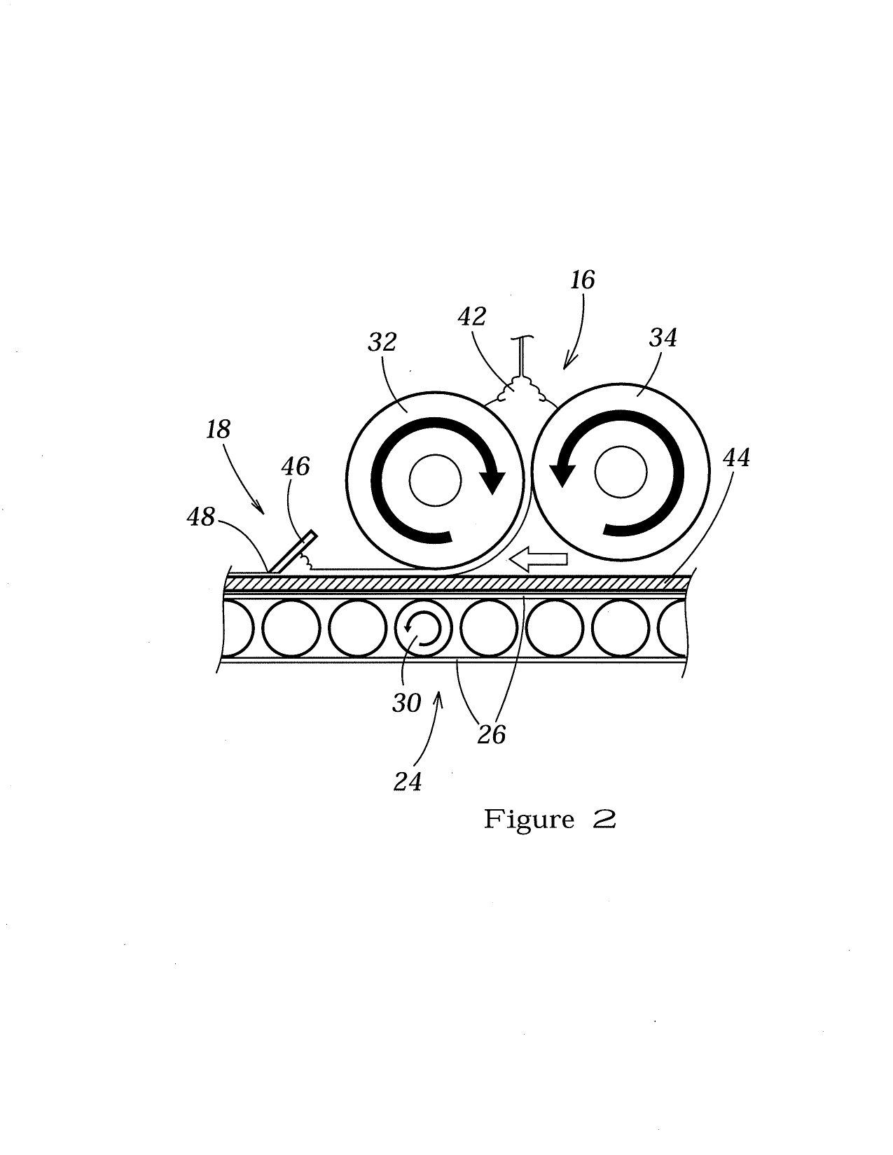

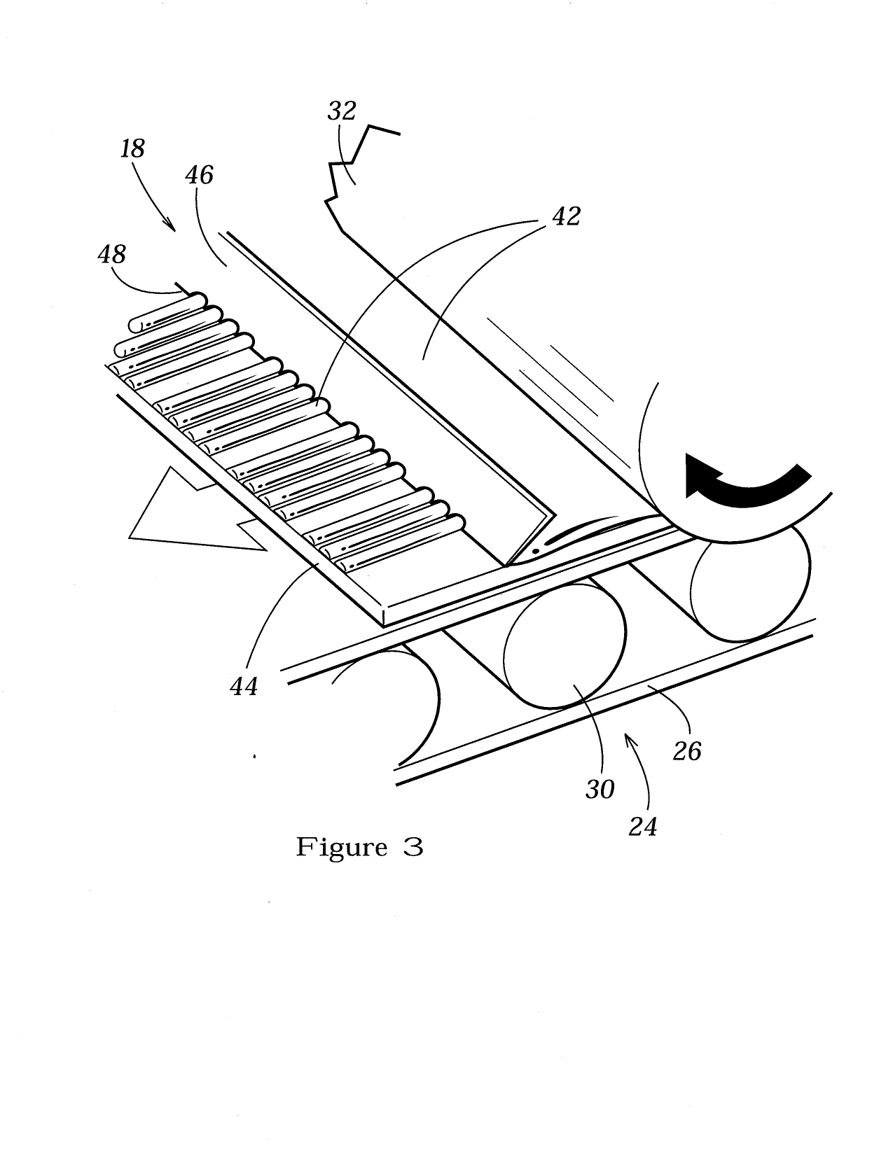

As noted above, the doctor blade 46 imparts the textured/pattern into the coating material 38 on the substrate 12. To achieve this, the doctor blade 46 has a profiled lower edge 48 that is encountered by the coating material 38. This is more readily seen in FIGS. 2 and 3. The peripheral edge 48 is provided with a series of recesses 50 that correspond to the desired pattern or texture that is to be formed in the coating material 38 on the substrate 12. The recesses 50 may have common depths or be of different depth, and may be equally spaced on the profiled edge 48 or spaced at different or repeating intervals. Additionally, the recesses 50 themselves can have a variety of shapes, including, without limitation, semi-circular, oval, ellipsoidal, rectangular or another polygonal shape, and partial portions thereof. The recesses 50 may also be provided along the profiled edge so as to define either a random series of recesses or a repeating series of recesses.

As the coated substrate 12 is conveyed past the doctor blade 46, the recesses 50 of the profiled edge 48 shape the coating material 38, which results in the pattern of the profiled edge 48 being transferred to the coating material 38. To achieve this, the profiled edge 48 of the doctor blade 46 brought into contact the upper surface 44 of the substrate 12. The profiled edge 48 may, however, only contact the coating material 38 in order to form the texture therein.

If the texture is to form a linear design on the wall board 13, then the doctor blade 46 is maintained stationary relative to the passing substrate 12. However, in an alternative embodiment, the doctor blade 46 need not remain stationary. Rather, it can be moved either transversely relative to the movement of the substrates 12 or it can be moved in a vertical direction (normal to the surface 44 of the substrate 12) to form a non-linear pattern or uneven surface.

It should also be noted that the doctor blade 46 can be provided in different configurations. For example, the doctor blade 46 could be provided in the form of an additional roller having a patterned surface which imprints the coating material 38 with the texture. In a further embodiment, the doctor blade 46 could be provided as a plate having a pattern formed on its surface, and which is periodically pressed into the coating material 38 so as to form a texture therein.

Once the texture has been formed in the coating material 38 on the substrate 12, the substrate 12 is then transferred to the curing station 20. The curing station 20 of the present invention uses ultraviolet (UV) light within a UV oven 52 to cure the coating. While the term “oven” is used herein, it should be understood that the UV oven 52 need not necessarily develop or provide heat, other than that which is incidentally formed in the UV oven 52 by the UV lamps. To achieve this, the UV oven 52 is provided with series of UV lamps or sources 54 that emit an amount of ultraviolet light that is sufficient to fully or substantially fully cure (dry and harden) the coating material 38 within the time period that the substrate 12 is located within the UV oven 52, which may be only about 15 to 30 seconds. As a result of this photochemical process, upon exiting the UV oven 52 the coated substrate 12 has been converted into the wallboard 13 and has a hardened, textured surface provided thereon. From the UV oven 52 of the curing station 20, the wall board 13 proceeds to the out-feed station 22 where the wallboard 13 may be stacked and packaged for shipment or transferred for further process. As an example of further processing, the finished wallboard 13 may be transferred to another production line where the textured surface of the wallboard 13 has a primer or paint coating applied to it. Notably, these primer/painting stations could be fully integrated with the production line 10 of FIG. 1, if desired.

The substrates 12 utilized in the present invention are generally planar and are constructed of a material that is suitable for the desired purpose, which as described herein is for use as wallboard, although the invention is not intended to be limited the manufacture of products only for such purposes. Once preferred substrate 12 is a board or panel known as a magnesia board or a magnesium oxide board. As the later name implies, this substrate 12 includes magnesium oxide as one of its principal components. In such a board, magnesium oxide is combined with a cement product, and a variety of other materials, the combination of which is then cast to form a rigid panel. Since the manufacturing of magnesium oxide boards is well known, further discussion of this technology is not provided herein.

As it is apparent from the prior discussion, the coating material 38 used in the present invention is a UV curable material. Such materials are often based upon epoxy, acrylates, urethane acrylates, polyester acrylates, polyether acrylates, amino modified polyether acrylates, acrylic acrylates and various other acrylates. Such coatings can also be based upon unsaturated polyester with styrene, for example. The above identification of chemical families is only intended to be illustrative and should not be considered as limiting the chemical family upon which the UV coating materials used with the present invention can be based. The particular composition of the UV coating material will ultimately depend on the intended end use of the wallboard 13 and the desired performance characteristics.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

I claim:

1. A method of manufacturing a substrate having a textured surface, the method comprising the steps of:
providing a substrate having a surface;
applying a coating material onto the surface of the substrate;
texturing the coating material on the surface of the substrate to form a textured coating; and
exposing the textured coating on the substrate to ultraviolet light for a duration of time sufficient to fully cure the textured coating on the substrate; and
thereby forming a fully cured textured surface on the substrate.

2. The method of claim 1 wherein the step of applying the coating material to the surface of the substrate includes the step of first applying the coating material to a pair of counter rotating rollers.

3. The method of claim 2 wherein the method of applying the coating material to the surface of the substrate includes contacting at least one of the rolls with the surface of the substrate thereby transferring the coating material from the roller to the surface of the substrate.

4. The method of claim 1 wherein the step of applying the coating material to the surface of the substrate include roll coating the substrate in a coating station.

5. The method of claim 1 wherein the surface of the substrate is planar.

6. The method of claim 1 wherein the substrate is moved along a conveyor belt during the coating, texturing and curing steps.

7. The method of claim 1 wherein the step of texturing the coating material on the surface of the substrate includes drawing the substrate with the coating material thereon past a doctor blade, the doctor blade having a profiled edge and the profiled edge contacting at least the coating material and thereby forming a texture in the coating material that corresponds with the shape of the profiled edge.

8. The method of claim 7 wherein the profiled edge includes a series of recesses.

9. The method of claim 8 wherein the series of recesses is a random series of recess.

10. The method of claim 8 wherein the series of recesses is a repeating series of recess.
